(19) United States
(12) Patent Application Publication
(10) Pub. No.: US 2004/0156556 A1
(43) Pub. Date: Aug. 12, 2004

(54) Image processing method

(76) Inventor: Javier Olivan Lopez, Munchen (DE)

Correspondence Address: BELL, BOYD & LLOYD, LLC, P. O. BOX 1135, CHICAGO, IL, 60690-1135, US

(21) Appl. No.: 10/476,067

(22) PCT Filed: Apr. 8, 2002
(86) PCT No.: PCT/DE02/01276

(30) Foreign Application Priority Data
Apr. 25, 2001 (DE) 101 20 286.5

(51) Int. Cl. G06K 9/36

(52) U.S. Cl. 382/276; 345/647

(57) ABSTRACT

The invention relates to an image processing method for optically displaying information and/or signals, whereby a source image (10) is transformed into a target image (10″) that is distorted or deformed in relation to the source image. According to the invention, a deformation vector (11), which determines a deformation direction, is defined in the source image (10) and a respective corresponding co-ordinate position is determined in the target image for each image pixel of the source image (10) according to a functional transformation rule that is dependent on said deformation vector (11) and to a scaling factor (31) that takes into consideration the position of each image pixel in relation to the deformation vector (11). Preferably, the scaling factor (31) has an elliptical functional form.

The invention relates to an image processing method for the visual display of information and/or signals whereby a source image is transformed into a target image that is distorted relative to said source image.

Methods of this kind are known as warping algorithms and are used for distorting images, generally on the basis of a polygonal mesh as the warping mask. As the provision of a family of vectors is required, these are complex techniques which naturally require a large amount of memory and are therefore also compute-intensive. Consequently, the methods according to the prior art can only be used in comparatively large computer systems, i.e. workstations or the like.

The object of the invention, in contrast, is to create an image processing method of the type mentioned above which requires less memory than methods according to the prior art and which can therefore be used in small microprocessor-based devices with relatively small data memory modules, as is the case, for example, in mobile telephones or the like.

This object is achieved by the method according to the invention in that, in an initialization phase, a deformation vector which determines a deformation direction is defined within the source image and a corresponding coordinate position is determined in the target image for each pixel of the source image according to a transformation rule that is functionally dependent on said vector and on a scaling factor that takes account of the position of each pixel in relation to the deformation vector.

Whereas existing methods based on the provision of vector fields are particularly memory- and compute-intensive and can therefore be used virtually only on larger computers (workstations) and achieve satisfactory results, the method according to the invention, on the other hand, based on a single vector determining the deformation direction, requires relatively little memory and is therefore also suitable for relatively small memory modules of the kind typically used in mobile telephones.

A preferred embodiment of the image processing method according to the invention consists in assigning the scaling factor an essentially elliptical function curve in such a way that the deformation vector extends approximately between the foci of the elliptical function curve. In contrast to the prior art whose polygon method produces angular contours in the target image, the present invention, on the other hand, produces round structures in the target image with the result that the method according to the invention is particularly suitable for source images having natural shapes such as e.g. faces, bodies or the like.

In addition, the assigned scaling factor value is determined for each source image pixel, said scaling factor being essentially dependent on the sum S=A₀+A₁ of the distance A₀ of the relevant pixel (x, y) from the starting point (x₀, y₀ of the deformation vector and the distance A₁ of the relevant pixel from the end point (x₁, y₁) of the deformation vector on the one hand and on the length L of the deformation vector on the other. According to an advantageous development of the image processing method according to the invention, to implement the elliptical function curve of the scaling factor the assigned scaling factor value is determined according to 1−((S−αL)/(αL)) for each source image pixel, where α is an adjustable constant, and if the value determined is greater than zero, this positive value is assigned to the relevant pixel, whereas, if not, the scaling factor value is set to zero for this pixel. In order to transform a source image into a target image that is distorted relative to said source image, the relevant target image pixels are determined using the relevant scaling factor value from the coordinate summation of the relevant source image pixels corresponding thereto with the coordinate-formed product of the scaling factor determined and the deformation vector.

In a following method step, the voids occurring in the target image because of the transformation are filled in with newly generated image pixels by interpolating corresponding color density values for the newly generated pixels from the relevant color density values of adjacently disposed pixels. By filling in such empty regions with image pixels appropriately mapped from adjacently thereto, the target image is sharper compared to using existing methods in which such areas are filled with image pixels of uniform color density value.

Further advantageous embodiments of the image processing method according to the invention will emerge from the sub-claims.

In terms of a technical arrangement for performing the image processing method, the aforementioned object is achieved in that a deformation vector which determines a deformation direction can be defined within the source image, and a corresponding coordinate position can be determined in the target image for each pixel of the source image according to a transformation rule that is functionally dependent on said vector and subject to a scaling factor that takes account of the position of each image pixel in relation to the deformation vector, the scaling factor having an essentially elliptical function curve and the deformation vector extending approximately between the foci of said elliptical function curve. As only a single vector is necessary for defining a deformation, the arrangement according to the invention requires relatively little memory and can therefore be advantageously used not only in small microcomputer-based portable or mobile devices, but also on a stand-alone basis.

An embodiment of the method according to the invention will now be explained in greater detail with reference to the accompanying drawings and schematics:

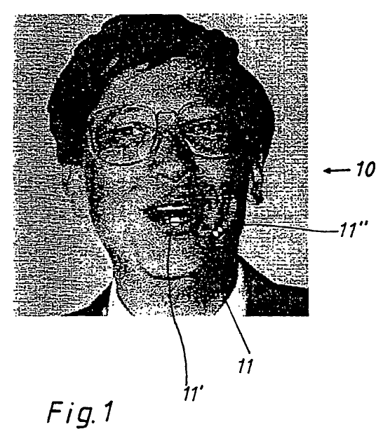

FIG. 1 shows a source image created as gray scale photography,

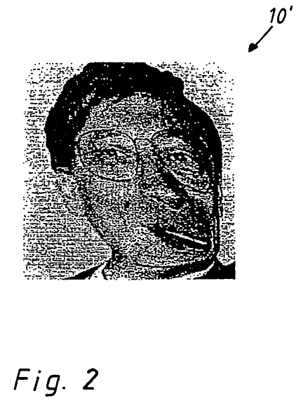

FIG. 2 shows a target image produced from the source image in FIG. 1 according to the prior art,

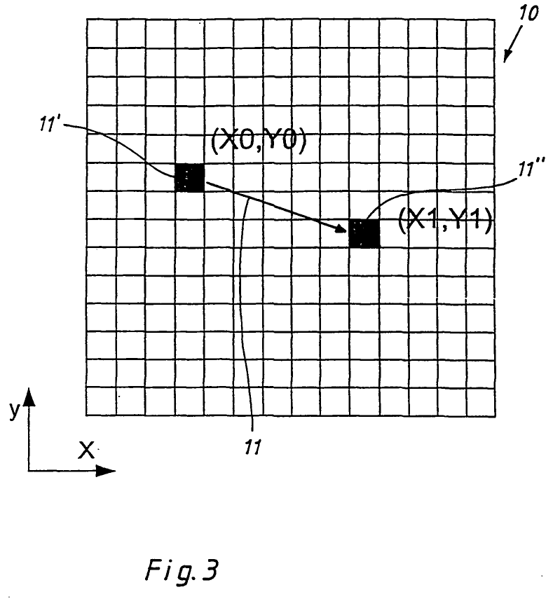

FIG. 3 is a simplified representation of a deformation vector defined on the basis of its starting point and end point within a source image pixel matrix according to an initialization phase of the method according to the invention,

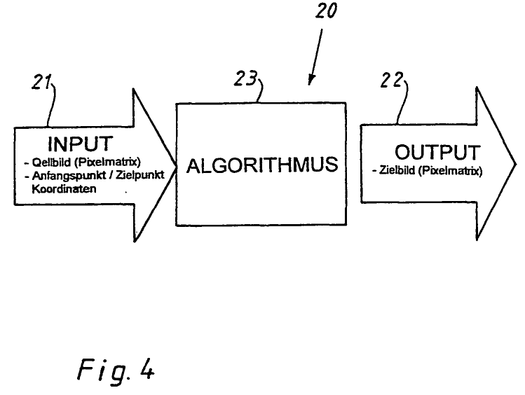

FIG. 4 shows an input/output flow diagram of the method according to the invention, the source image pixel matrix and the coordinates of the deformation vector being fed in as input variables of the method and a target image pixel matrix being determined as the output variable,

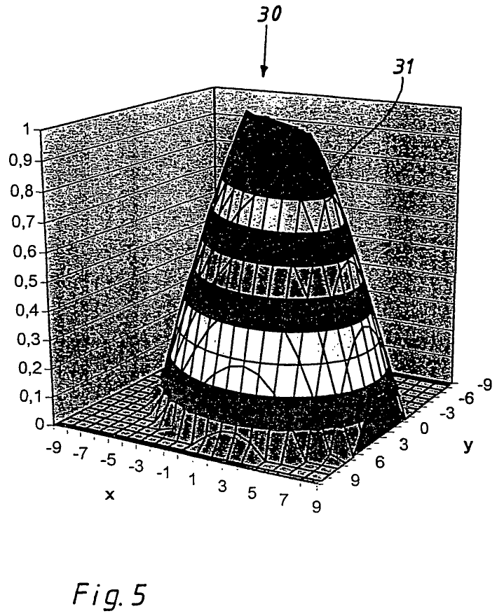

FIG. 5 is a perspective view of the function curve of an exemplary embodiment of the scaling factor associated with the method according to the invention,

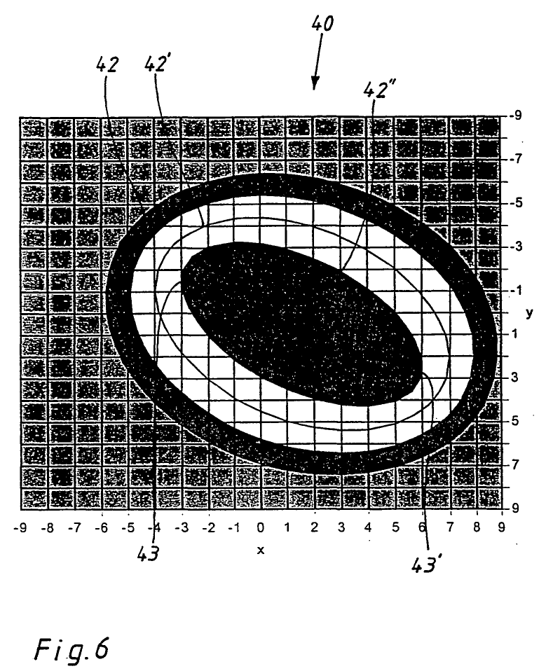

FIG. 6 shows a contour diagram of the function curve of the scaling factor in FIG. 5,

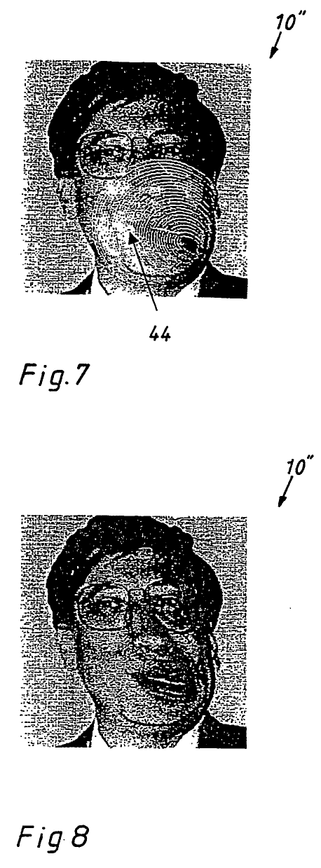

FIG. 7 shows a target image produced from the source image in FIG. 1 using the method according to the invention prior to a final interpolation step, approximately circularly disposed structural light areas representing defects in the target image, and

FIG. 8 shows the target image from FIG. 7 with interpolation performed after the method according to the invention, whereby defects resulting from the transformation have been filled in.

The method according to the invention is used for warping an original or source image composed of information signals, said source image being transformed into a target image that is distorted relative to said source image.

FIG. 1 shows an example of a source image 10. FIG. 2 shows a target image 10′ that has been distorted relative to the source image 10 using a method according to the prior art by providing the source image 10 with a mesh—not shown separately here—of polygons and deforming said mesh together with the assigned image pixels. Because of the large number of vectors required for this purpose, these conventional methods require a large amount of memory and are therefore very compute-intensive. In addition, the target image 10′ resulting from polygon deformation exhibits angular structures.

This is where the method according to the invention provides a solution whereby, in a source image 10 characterized by a pixel matrix, a deformation or distortion direction is defined or determined by a single deformation vector 11 (illustrated in FIG. 3) during an initialization phase, said deformation vector 11 being defined by the starting point 11′ having the starting point coordinates (x₀, y₀) and an end point 11″ having the end point coordinates (x₁, y₁) and both the starting point 11′ and the end point 11″ being within the pixel matrix of the source image 10. This initialization phase is illustrated by the source image 10 created as gray scale photography shown in FIG. 1 with a projection of a deformation vector 11.

FIG. 4 shows a basic flow diagram 20 of the method according to the invention, the pixel matrix of the source image 10 and the coordinates of the starting point 11′ and end point 11″ of the deformation vector 11 being entered as the input variables 21, whereas the pixel matrix of the target image is determined as the output variable 22 using a transformation equation 23.

In this method step, a coordinate position (x_{z}, y_{z}) in the pixel matrix of the target image is determined for each pixel (x_{Q}, y_{Q}) from the pixel matrix of the source image 10, this step being based on the following transformation equation in matrix notation:

$$( \begin{matrix}{x}_{Z} \\ {y}_{Z}\end{matrix} ) = ( \begin{matrix}{x}_{Q} \\ {y}_{Q}\end{matrix} ) + ( \begin{matrix}F ( {x}_{Q} , {y}_{Q} , K ) & 0 \\ 0 & F ( {x}_{Q} , {y}_{Q} , K )\end{matrix} ) ( \begin{matrix}{x}_{1} - {x}_{0} \\ {y}_{1} - {y}_{0}\end{matrix} )$$

Here, the right-hand side of the transformation equation has, as input variables 21, the relevant pixels (x_{Q}, Y_{Q}) of the matrix of the source image 10 as well as the deformation vector 11 (x₁−x₀, y₁−y₀) defined by the difference between the starting point and end point coordinates (x₀, y₀) and (x₁, y₁) respectively and a scaling factor F(x,y,K), whereas the left-hand side of the transformation equation, on the other hand, reproduces the assigned pixels (x_{z}, y_{z}) of the matrix of the target image as output variables 22; the scaling factor is included in each case as the main diagonal element of a (2×2) matrix whose off-diagonal elements are each zero, the product of the (2×2) matrix and the deformation vector 11 added to the coordinates of the relevant source image pixel (x_{Q}, y_{Q}) yielding the corresponding target image pixel (x_{z}, y_{z}). The scaling factor F(x,y,K) included in the transformation equation is functionally dependent on the relative distance of the relevant pixel (x, y) of the source image with respect to the starting point (x₀, y₀) and to the end point (x₁, y₁) of the deformation vector 11 and a variable K:

$$F ( x , y , K ) = 1 - \frac{\sqrt{{( x - {x}_{0} )}^{2} + {( y - {y}_{0} )}^{2}} + \sqrt{{( x - {x}_{1} )}^{2} + {( y - {y}_{1} )}^{2}} - K}{K}$$

If this expression for an entered pixel (x, y) of the source image 10 assumes a value F>0, this positive value is assigned to this pixel and stored; otherwise this value is set to F=0, the variable K being dependent on the one hand on the length of the deformation vector 11 and, on the other, on an adjustable constant α, where the following relation applies to K:

K=α\sqrt{(x₁−x₀)²+(y₁−y₀)²}

In the transformation, the relevant pixels of the source image 10 are therefore shifted according to their respective distances from the starting point and end point 11′, 11″ in the direction of the deformation vector 11 determined by the starting point 11′ and the end point 11″. The degree of shifting or distortion is dependent on the scaling factor F(x,y,K) appearing in the transformation equation and which is essentially determined from the sum of the distances of the respective pixels from the starting point and end point 11′, 11″ in relation to the length of the deformation vector 11, so that pixels disposed in the immediate vicinity of the vector 11, i.e. the starting point and end point, experience a greater shift than those pixels disposed at greater distances therefrom, whereas pixels very far from the deformation vector 11 remain virtually unshifted.

FIG. 5 illustrates in a perspective view 30 the graphical function curve of the scaling factor 31, the values α=1 and K=8.6023 having been selected for the parameters α and K respectively and the deformation vector being defined using its starting point coordinates (−2, −2) and its end point coordinates (3, 5).

FIG. 6 is a contour diagram 40 illustrating the function curve of the scaling factor 31. Using a plurality of elliptically curved contour or equipotential lines 42, 42′, 42″, this diagram 40 shows that the scaling factor function 31 has an elliptical cross-section. The foci 43, 43′ of an ellipse of this kind each coincide with the starting point and end point 11′ and 11″ respectively of the deformation vector 11. Pixels lying on an ellipse of this kind with starting point 11′ and end point 11″ of the deformation vector 11 as foci 43, 43′ are shifted by the same amount.

In a further method step, gaps resulting from the transformation which are indicated in FIG. 7 by circular structural light areas 44 are filled up in the target mapping, i.e. in the pixel matrix of the target image 10″. These gaps are regions in the target image 10″ into which no pixels or only a very small number of pixels of the source image 10 are mapped, which means that these areas in the target image 10″ have no correspondence in the source image 10. In this step, these areas of the target image 10″ are filled in with newly generated pixels by determining transformed pixels disposed adjacently to these empty areas and the corresponding color density values are determined from their assigned color densities by interpolation, assigned and stored for the new pixels to be generated. FIG. 8 shows the target image 10″ for which this interpolation has been performed; because of the abovementioned properties of the scaling factor function, the target image 10″ has round structures in the deformed areas, which means that the method is advantageously suitable for representing natural shapes.

1. Image processing method for visually displaying information and/or signals, a source image being transformed into a distorted or warped target image,
characterized in that a deformation vector (11) which determines a deformation direction is defined within the source image (10) and a corresponding coordinate position is determined in the target image (10″) for each pixel of the source image (10) according to a transformation rule (23) that is functionally dependent on said deformation vector (11) and on a scaling factor (31) that takes account of the position of each pixel in relation to the deformation vector (11).

2. Image processing method according to claim 1,
characterized in that an essentially elliptical function curve is assigned to the scaling factor (31) in such a way that the deformation vector (11) extends approximately between the foci (43, 43′) of the elliptical function curve.

3. Image processing method according to claim 1 or 2,
characterized in that the assigned scaling factor value (31) is determined for each source image pixel (10), said scaling factor (31) being essentially dependent, on the one hand, on the sum S=A₀+A₁ of the distance A₀ of the relevant image pixel (x, y) from the deformation vector starting point (11′) designated by the coordinates (x₀, y₀) and the distance A₁ of the relevant image pixel from the deformation vector end point (11″) designated by the coordinates (x₁, y₁) and, on the other hand, on the length L of the deformation vector (11).

4. Image processing method according to claim 3,
characterized in that the assigned value of the scaling factor (31) is determined according to 1−((S−αL)/(αL)) for each pixel of the source image (10), α being an adjustable constant, and if the value determined is greater than zero, this positive value is assigned to the relevant pixel, whereas, if not, the value of the scaling factor (31) is set to zero for this pixel.

5. Image processing method according to one of claims 2 to 4,
characterized in that the relevant pixels of the target image (10″) are determined from coordinate summation of the corresponding pixels of the source image (10) with the coordinate-formed product of the scaling factor (31) determined and the deformation vector (11).

6. Image processing method according to one of claims 2 to 5,
characterized in that the relations A₀=((x−x₀)²+(y−y₀)²)^{1/2} and A₁=((x−x₁)²+(y−y₁)²⁾^{1/2} are respectively defined as the distance A₀ of the relevant image pixel (x, y) from the starting point (11′), designated by the coordinates (x₀, y₀), of the deformation vector (11) and as the distance A₁ of the relevant pixel from its end point (11) designated by the coordinates (x₁, y₁).

7. Image processing method according to one of claims 1 to 6,
characterized in that the length of the deformation vector (11) is calculated according to the relation L=((x₁−x₀)²+(y₁−y₀)²)^{1/2}.

8. Method according to one of claims 1 to 7, characterized in that voids occurring in the target image (10″) because of the transformation are filled in with newly generated pixels by interpolating corresponding color density values for the newly generated pixels from the relevant color density values of adjacently disposed pixels.

9. Arrangement for performing the image processing method particularly according to one of claims 1 to 8, characterized in that a deformation vector (11) which determines a deformation direction can be defined within the source image (10) and a corresponding coordinate position can be determined in the target image (10″) for each pixel of the source image (10) according to a transformation rule (23) that is functionally dependent on said deformation vector (11) and on a scaling factor (31) that takes account of the position of each pixel in relation to the deformation vector (11).

10. Arrangement according to claim 9, characterized in that the scaling factor (31) has an essentially elliptical function curve, the deformation vector (11) extending approximately between the foci (43, 43′) of the elliptical function curve.
